(19) United States
(12) Patent Application Publication
(10) Pub. No.: US 2003/0165081 A1
(43) Pub. Date: Sep. 4, 2003

(54) Stationary type fluid mixer

(76) Inventors: Kazunori Mizutani, Aichi (JP); Toshiyuki Nagai, Aichi (JP)

Correspondence Address: Flynn Thiel Boutell & Tanis, 2026 Rambling road, Kalamazoo, MI, 49008-1699, US

(21) Appl. No.: 10/332,250

(22) PCT Filed: Jul. 2, 2001
(86) PCT No.: PCT/JP01/05732

(30) Foreign Application Priority Data
Jul. 6, 2000 (JP) 2000-204475

(51) Int. Cl. B01F 5/06

(52) U.S. Cl. 366/340

(57) ABSTRACT

A stationary type fluid mixer adapted to improve mixing/dispersion efficiencies, to easily cope with the increase and decrease of the total number of divisions, to prevent the stationary type fluid mixer from being long and large sized, to increase the degree of freedom of setting of the number of divisions, to facilitate the adjustment of the degree of mixing/dispersion according to different types of fluids, to dispense with a housing, to improve safety, and to make washing possible without disassembling, the mixer comprising a laminated structure (6) composed of a center plate (4) and side plates (5), through-holes (7) and outlet/inlet ports (8) which communicate with each other through communication flow paths (9) composed of a plurality of annular grooves (10, 10a) and radial communication grooves (11, 11a) disposed between the annular grooves (10, 10a), seal bodies (16) disposed between the center plate (4) and the side plates (5), a fixing clip (17) fitted on the laminated structure (6), the fixing clip (17) elastically urging the side plates (5) against the opposite surfaces of the center plate (4), thus constituting a fluid flow path assembly (2), which is fixedly held between fluid couplings (3).

### TECHNICAL FIELD

The invention relates to a stationary type fluid mixer to be used in a process for mixing multiple fluids.

### BACKGROUND TECHNOLOGY

A static mixer which has been conventionally widely used for continuously mixing and dispersing multiple fluids in a production line of industrial fields of chemicals, foodstuffs, medicines, cosmetics is known as illustrated in FIGS. 25 to 27 wherein a plurality of mixing elements B are engaged axially and serially in a cylindrical housing A.

The elements B comprise mixing elements B1 each formed by twisting an end portion of a rectangular plate 180° rightward and mixing elements B2 each formed by twisting an end portion of the rectangular plate 180° leftward, wherein end portions of both the mixing elements B1, B2 cross with each other at right angles and both the mixing elements B1, B2 are arranged alternately in the manner that a twisting direction is inverted. A mixing/dispersion principle of this static mixer is formed of the combination of “division of flow”, “inversion of flow” and “changeover of flow”.

Meanwhile, the number of divisions by such a static mixer is required for the adjustment of the degree of mixing/dispersion, whereupon “division of flow”, one of the mixing/dispersion principle is single dividing function for merely fixedly dividing fluid into two by the stand-alone mixing elements B. The mixing elements B per se can not change the number of divisions, and hence the adjustment of the number of divisions can be coped with the increase or decrease of the number of mixing elements B which are serially arranged, and the increase of the divisions has a problem to indispensably make the static mixer long and large sized.

Further, the “inversion of flow” means that rotating direction of fluid is changed from right to left or left to right every mixing elements B and fluid receives inversion of inertia force at this time to effect mixing/dispersion operation. The “changeover of flow” means that flow of fluid is rearranged from a central portion to the wall portion of the cylindrical housing A or from the wall portion to the central portion thereof along the twisted surfaces of the mixing elements B, and either of direction of flow of fluid is centrifugalized, and owing to the centrifugal force, if multiple fluids to be mixed and dispersed and having difference in gravity operate to separate a material to be mixed and dispersed on the contrary to the mixing/dispersion, thereby causing a problem of deterioration of mixing/dispersion efficiency.

Further, the stand-alone mixing element B does not function as the static mixer and it always needs the cylindrical housing A having strength withstanding a fluid pressure, and it is difficult to use a general sealing device such as an O-ring, a gasket, and the like because a sealed portion between the mixing elements B and cylindrical housing A so as to apply sealing function therebetween is formed of a string-like interrupted curve, and hence an edge seal system for directly welding the mixing elements B and cylindrical housing A is used, which has however a problem that such a system is expensive and the stand-alone elements B can not be replaced with another mixing elements B.

### DISCLOSURE OF THE INVENTION

In view of the problems of the background technology set forth above, namely, single dividing function, long and large size, deterioration of mixing/dispersion efficiency, high cost, necessity of a housing having a strength withstanding a pressure, a material of the mixer, the present invention has been developed to solve the problems set forth above and to provide a stationary type fluid mixer adapted to reduce the number of parts to reduce a cost by including a center plate and side plates, to form complex collision paths therein to improve mixing/dispersion efficiency by a compound shear force caused by collision between fluids mutually and collision of fluid against the wall surface which are organically repeated, to easily cope with the need for increasing and decreasing the number of divisions, to prevent the stationary type fluid mixer from becoming long and large sized, to increase the degree of freedom of setting of the number of divisions, to facilitate the adjustment of the degree of mixing/dispersion according to different types of fluids, to dispense with a housing by preventing fluid from being leaked between the center plate and side plates, to improve safety, to make washing possible without disassembling a fluid path structure.

That is, the stationary type fluid mixer comprises a center plate, side plates, seal bodies, a fixing clip and fluid couplings, wherein side plates are laminated on opposite surfaces of the center plate to form a laminated structure, the outer peripheral side of the center plate is bored to form a plurality of through-holes and the central sides of the side plates are bored to form outlet/inlet ports, and the outlet/inlet ports and the through-holes communicate with each other by communication flow paths.

The communication flow paths are comprised of a plurality of annular grooves formed concentrically in either a laminated surface of the center plate or laminated surfaces of the side plates, and the annular groove which is positioned at the outermost side of the annular grooves is allowed to communicate with the through-holes, a plurality of radial communication grooves being defined between the inner and outer annular grooves, wherein the communication groove which is positioned at the outermost side of the communication grooves is positioned at a midpoint of the through-holes in a circumferential direction, and a plurality of radial communication grooves are defined on the laminated surface of the inner side of the annular groove which is positioned at the innermost side to communicate with the outlet/inlet ports, and the inner and outer communication grooves are positioned at the midpoint thereof in a circumferential direction.

Further, flow path sectional areas of the through-holes and the communication grooves are the same, and the flow path sectional areas of annular grooves are the same, and the flow path sectional areas of the annular grooves are set to be half as large as those of the through-holes and the communication grooves, and planate collision surfaces are provided on the sidewall surfaces of the annular grooves facing the communication grooves. Further, a tip end of each projection formed by the communication grooves is exposed to an interior of the outlet/inlet ports to constitute the fluid flow path assembly.

Still further, seal bodies formed of rubber-like elastic body are provided between the laminated surface of the center plate positioned outside the through-holes and the laminated surface of the side plates, and a fixing plate made of a material of a leaf spring and formed in substantially U-shape is fitted on the outer side of the laminated structure, and the side plates are elastically urged by the fixing clip against opposite surfaces of the center plate to constitute the fluid flow path assembly, which is fixedly held between fluid couplings.

### BRIEF DESCRIPTION OF DRAWINGS

FIG. 1 is a schematic sectional view showing a stationary type fluid mixer according to the invention,

FIG. 2 is a plan view showing a center plate,

FIG. 3 is a sectional view showing the center plate, and

FIG. 4 is a partial plan view showing the center plate.

FIG. 5 is a is a plan view showing a side plate,

FIG. 6 is a sectional view showing the side plate in FIG. 5,

FIG. 7 is a plan view showing another embodiment of a side plate, and

FIG. 8 is a sectional view showing the side plate FIG. 7.

FIG. 9 is a schematic sectional view showing another embodiment of a stationary type fluid mixer, and

FIG. 10 is a schematic sectional view showing an embodiment of a seal fitting portion in a seal portion to be provided on the center plate.

FIG. 11 is a schematic sectional view showing another embodiment of the seal fitting portion,

FIG. 12 is a schematic sectional view showing still another embodiment of the seal fitting portion, and

FIG. 13 is a schematic sectional view showing more still another embodiment of the seal fitting portion.

FIG. 14 is a schematic sectional view showing a seal fitting portion to be provided on the side plate,

FIG. 15 is a schematic sectional view showing another embodiment of the seal fitting portion,

FIG. 16 is a schematic sectional view showing still another embodiment of a seal fitting portion, and

FIG. 17 is a schematic sectional view showing more still another embodiment of the seal fitting portion.

FIG. 18 is a schematic sectional view showing a laminated structure on which a seal body is fitted in a non-elastic urging state,

FIG. 19 is a view showing a fixing clip, and

FIG. 20 is a schematic sectional view showing the laminated structure on which the fixing clip is fitted.

FIG. 21 is a schematic sectional view showing a stationary type fluid mixer in which a plurality of fluid flow path assemblies are continuous with one another,

FIG. 22 is a schematic sectional view showing another embodiment of the stationary type fluid mixer,

FIG. 23 is a schematic sectional view showing still another embodiment of the stationary type fluid mixer, and

FIG. 24 is a schematic sectional view showing more still another embodiment of the stationary type fluid mixer.

FIG. 25 is a schematic sectional view showing an internal structure of a static mixer of a background technology,

FIG. 26 is a view showing a mixing element constituting the static mixer, and

FIG. 27 is a view showing another embodiment of a mixing element.

### BEST MODE FOR CARRYING OUT THE INVENTION

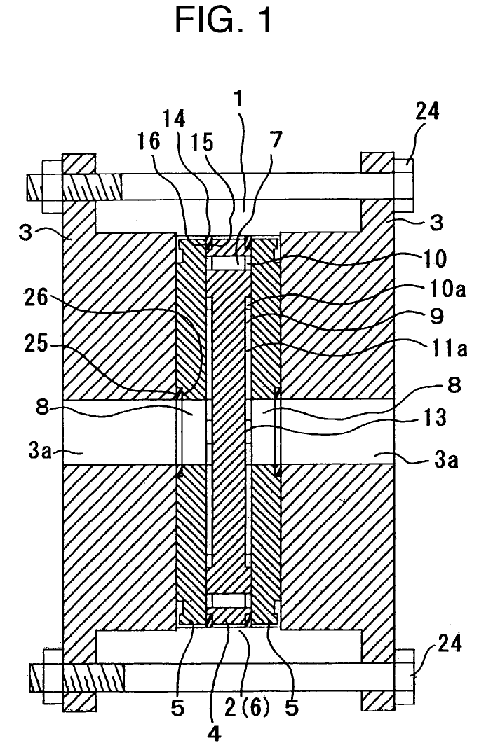

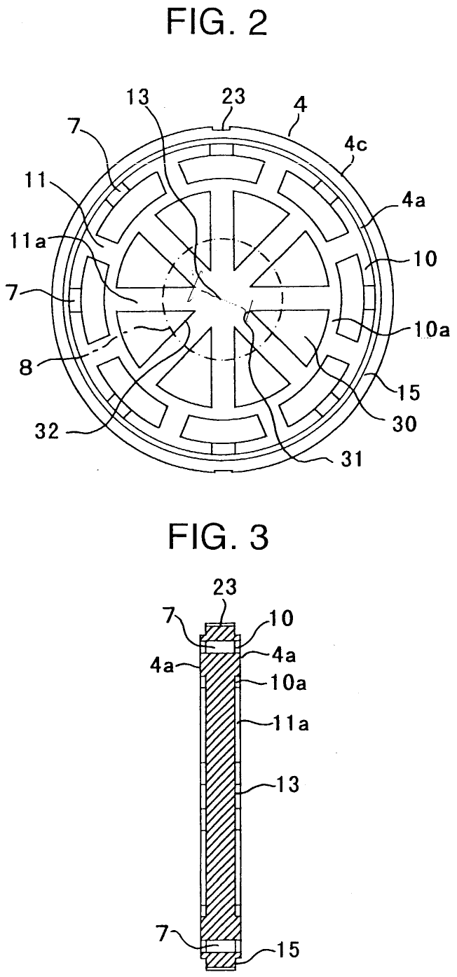

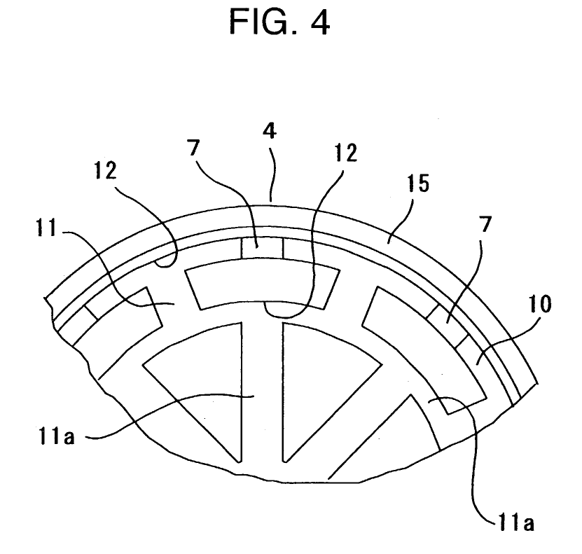

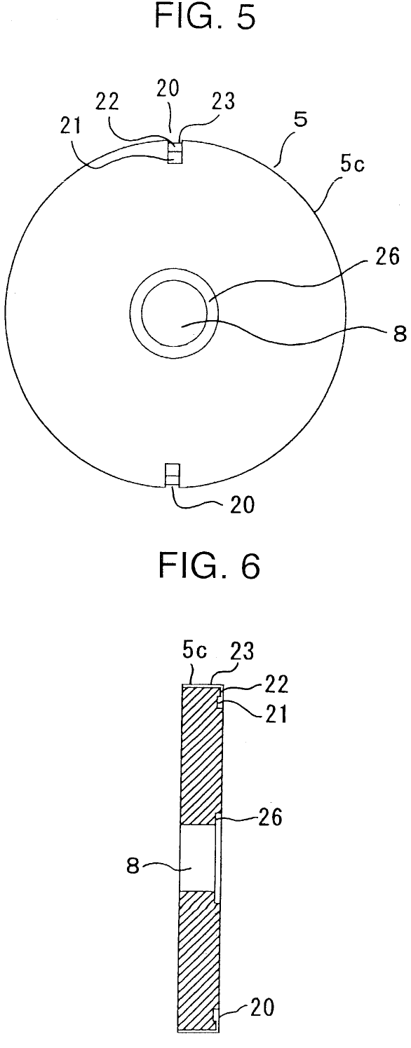

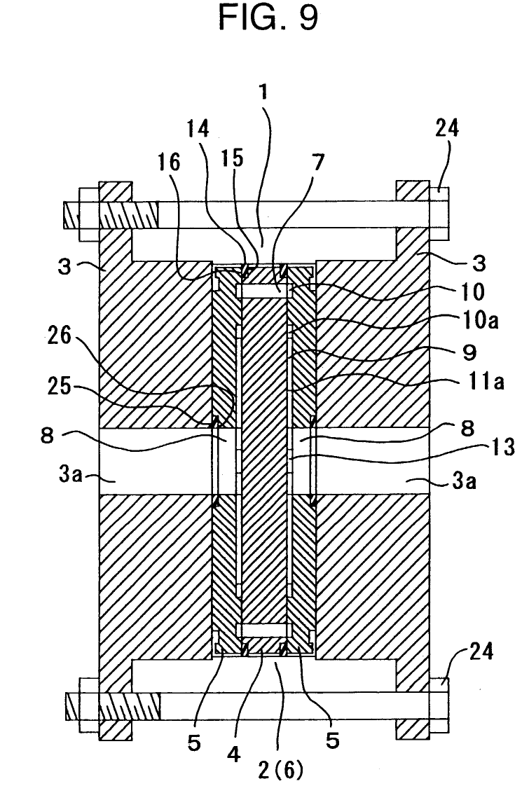

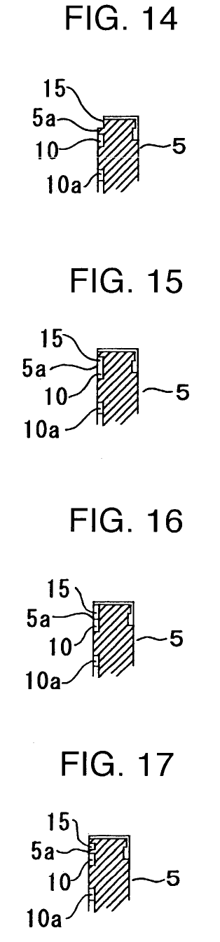

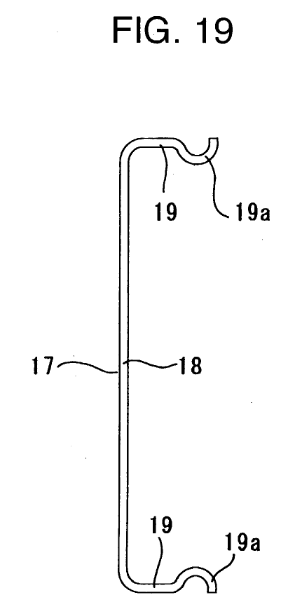

Embodiments of the invention are described hereinafter together with examples illustrated in FIGS. 1 to 24.

Depicted by 1 is a stationary type fluid mixer according to the invention, and the stationary type fluid mixer 1 comprises one or a plurality of fluid flow assemblies 2 and fluid couplings 3 connected to a piping (not shown).

The fluid flow path assembly 2 is formed of a laminated structure 6 comprised of a center plate 4 and side plates 5 which are laminated concentrically on opposite surfaces of the center plate 4, wherein the center plate 4 is formed in a circular shape and it is bored circumferentially along the center plate 4 while an outer peripheral side of a laminated surface 4a remains to form a plurality of through-holes 7, and each side plates 5 is formed in a circular shape and it is bored at the central side of each side plates 5 to form outlet/inlet ports 8.

Depicted 9 is communication flow paths for communicating between the outlet/inlet ports 8 and through-holes 7 in the laminated structure 6, and the communication flow paths 9 are formed on a laminated boundary side of the laminated surface 4a of the center plate 4 and a laminated surface 5a of the side plates 5 and is formed at least at either the laminated surface 4a or the laminated surface 5a.

That is, in the case where the communication flow paths 9 are formed on the center plate 4, a plurality of annular grooves 10, 10a each having a square shape in cross section and given inner and outer diameters, depth are formed concentrically on the laminated surface 4a of the center plate 4, wherein the annular groove 10 which is at the outermost side of the annular grooves 10, 10a communicates with a through-holes 7 positioned at the bottom thereof, and a plurality of radial communication grooves 11, each having a square shape in cross section and given inner and outer diameters, depth are formed on the laminated surface 4a between the annular grooves 10, 10a, wherein the communication groove 11 at the outermost side of the communication grooves 11 is positioned in the circumferential direction at the midpoint of the through-holes 7, and a plurality of other communication grooves ha are formed on the laminated surface 4a inside the annular groove 10a which is at the innermost side thereof in the circumferential direction, and wherein each communication groove 11a communicates with the outlet/inlet ports 8 of the side plates 5 and the inner and outer communication grooves 11, 11a constitute the communication flow paths 9 respectively positioned mutually at the midpoint thereof in the circumferential direction.

Each flow path sectional area of the through-holes 7, communication grooves 11, 11a is formed to be substantially the same with each other, and each flow path sectional area of the annular grooves 10, 10a is formed to be substantially the same with each other, wherein each flow path sectional area of the annular grooves 10, 10a maybe formed half of each flow path sectional area of the through-holes 7, communication grooves 11, 11a.

Further, a plurality of collision surfaces 12 are formed while the side wall surfaces of the annular grooves 10, 10a which face each other on the axial lines of the communication grooves 11, 11a are made planate. In the figures, depicted by 13 is recesses formed to face the outlet/inlet ports 8, and the recesses 13 are formed by the communication groove 11a which is formed at the innermost side of the communication grooves 11, 11a.

A plurality of substantially triangular projections 30 as viewed from the plane are formed on the spots which are surrounded by the communication grooves 11a and the innermost side annular groove 10a, wherein the diameter of the outlet/inlet ports 8 of the side plates 5 is made larger than the diameter of an imaginary circle which contacts the tip end 31 of each projection 30, and the tip end 31 side of the projections 30 is disposed to be exposed inside the outlet/inlet ports 8.

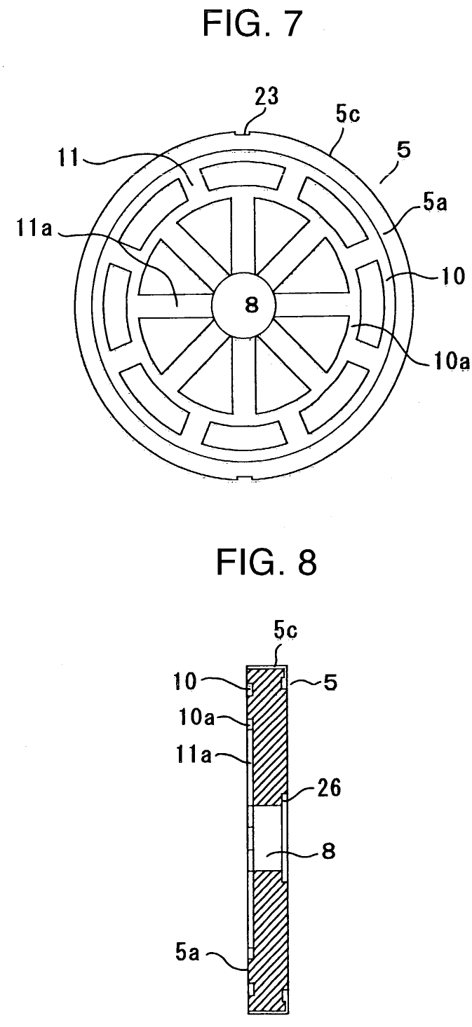

Further, as another embodiment of the communication flow paths 9, as shown in FIG. 7 and FIG. 8, a plurality of annular grooves 10, 10a are formed concentrically outside the outlet/inlet ports 8 of each laminated surface 5a of the side plates 5, wherein the annular groove 10 at the outermost side of the annular grooves 10, 10a is rendered to communicate with the through-holes 7 while facing the through-holes 7, and a plurality of radial communication groove 11 are formed on the laminated surface 4a between the inner and outer annular grooves 10, 10a, wherein the communication groove 11 which is at the outermost side of the communication grooves 11 is positioned at the midpoint of the through-holes 7 in the circumferential direction, and a plurality of other communication grooves 11 are formed on the inner laminated surface 5a of the annular groove 10a at the innermost side in the circumferential direction, wherein the communication grooves 11a communicate with the outlet/inlet ports 8, and the inner and outer communication grooves 11, 11a constitute the communication flow paths 9 while positioned mutually at the midpoint in the circumferential direction.

Further, the shapes of the center plate 4 and side plates 5 are not limited to the disc shape, for example, they may be polygonal more than triangular, if the center plate 4 and side plates 5 may be formed of plate-shape which can be laminated concentrically. Further, the materials of the center plate 4 and side plates 5 may be mechanical structure members such as metal, plastic, ceramic which are generally used as a fluid apparatus.

Further, the number of communication grooves 11, 11a, and annular grooves 10, 10a is set to be arbitrary so as to increase the repetition of division, collision, to increase the total number of divisions and collisions for enhancing the mixing/dispersion efficiency.

Depicted by 14 is seal portions, and the seal portions 14 are formed in the laminated structure 6 between the laminated surface 4a of the center plate 4 positioned outside the through-holes 7 and each laminated surface 5a of the side plates 5.

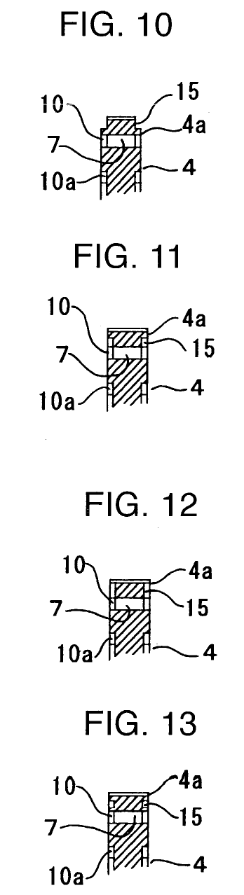

The seal portions 14 comprise seal fitting portions 15 and seal bodies 16 wherein each seal fitting portion 15 is formed outside the through-holes 7 of the laminated surface 4a of the center plate 4 in the manner of a step formation at the outer edge forming a part of the laminated surface 4a which remains on the center plate 4 as shown in FIG. 10, or of a step formation at the through-holes 7 side forming a part of the remaining laminated surface 4a so as to be continuous with the through-holes 7 as shown in FIG. 11, or of a step formation in which the entire remaining laminated surface 4a is stepped as shown in FIG. 12, or a step formation in which an annular recessed groove is stepped inside the remaining laminated surface 4a as shown in FIG. 13.

Further, as still another embodiment of the seal fitting portion 15, as shown in FIGS. 14 to 17, each seal fitting portion 15 is formed on each laminated surface 5a of the side plates 5 facing the remaining laminated surface 4a of the center plate 4 in the laminated structure 6 or the combination thereof can be performed, although not shown.

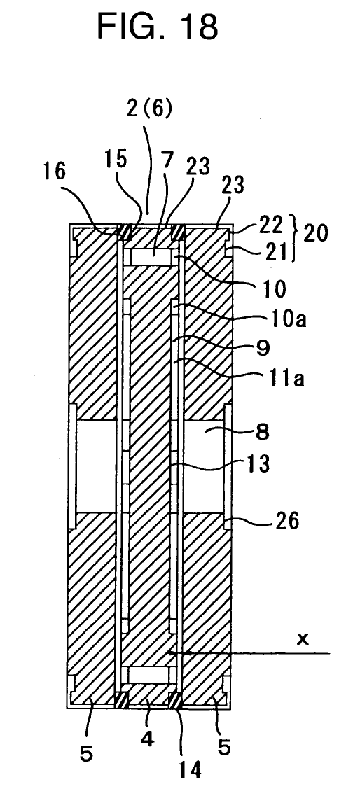

Still further, each seal body 16 is made of rubber-like elastic body and is formed in a ring shape, and the cross section thereof is a circular or square. The thickness of each seal body 16 is set such that a gap X is defined between the laminated surface 4a of the center plate 4 and each laminated surface 5a of the side plates 5 when each seal body 16 is fitted on the seal portions 14 in a non-elastic urging state as shown in FIG. 18, while the outer diameter of each seal body 16 is set not to protrude from the laminated structure 6 in a state where the seal fitting portions 15 are opened in outer portions as shown in FIGS. 10, 12, 14, and 16.

Depicted by 17 is a fixing clip made of strip-shaped leaf spring material, wherein a pair of elastic pieces 19 are formed on upper and lower portions of a coupling piece 18 in substantially U-shape and a retaining protrusion 19a is formed on each end portion of the elastic pieces 19.

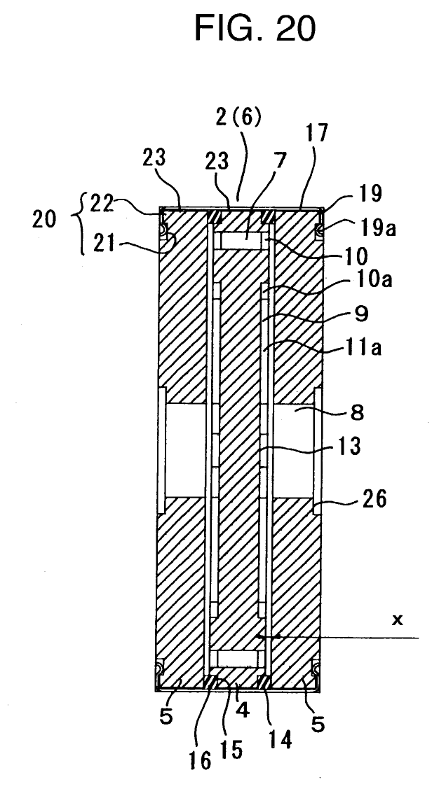

Further, as shown in FIG. 20, the fixing clip 17 is fitted on the laminated structure 6 from the outside thereof in a state where the seal body 16 is fitted on the seal portions 14 in a non-elastic urging state, wherein the side plates 5 are elastically urged against opposite surfaces of the center plate 4 by a pair of upper and lower coupling pieces 18 of the fixing clip 17, thereby elastically urging the seal body 16 against opposite surfaces of the center plate 4.

An elastic force of the fixing clip 17 in such an elastic urging state is set to the extent that the gap X between the laminated surface 4a of the center plate 4 and each laminated surface 5a of the side plates 5 is slightly narrowed, and is also set to apply a clamping pressure which is needed for each seal body 16 to be fitted on a flange of the seal portions 14.

Depicted by 20 is a retaining portions for restraining removal of the fixing clip 17, and it is provided on surfaces 5b of the side plates 5, wherein a pair of retaining recessed portions 21 are formed to be depressed at outer edges of the surfaces 5b which linearly face each other at least in a diametrical direction.

Further, retaining projections 22 are formed on outer edges of the interior of the retaining recessed portions 21 and retaining protrusion 19a of the elastic pieces 19 of the fixing clip 17 are engaged with and fixed to a retaining portion 20.

The depth ranging from the surfaces 5b of the side plates 5 to the bottom of the retaining recessed portions 21 of the retaining portion 20 or the depth from the surfaces 5b of the side plates 5 to the upper end face of the retaining projections 22 are set such that the fixing clip 17 does not protrude from the surfaces 5b when the retaining protrusion 19a are engaged with the retaining portion 20.

Depicted by the 23 is clamping grooves for restricting rotary positional displacement in the circumferential direction of the center plate 4 and side plates 5 of the laminated structure 6, wherein the clamping grooves 23 are formed to be depressed in outer peripheral surfaces 4c of the center plate 4 which is continuous with the retaining portion 20 so that the clamping grooves 23 are engaged in the coupling piece 18 of the fixing clip 17 or formed to be depressed in outer peripheral surfaces 5c of the side plates 5 which are linearly face each other in a diametrical direction, and the depth of clamping grooves 23 is set to be larger than the thickness of the fixing clip 17.

For assembling the stationary type fluid mixer 1, a fluid coupling 3 is connected to the outlet/inlet ports 8 on both sides of the fluid flow path assembly 2 so as to communicate with the connection ports 3a, then the fluid couplings 3 on both sides of the fluid flow path assembly 2 are fastened by a clamping means 24 such as bolts, nuts and the like until the laminated surface 4a of the center plate 4 and each laminated surface 5a of the side plates 5 are brought into close contact with each other so that the fluid flow path assembly 2 is fixedly held by the fluid coupling 3.

With such a fixedly holding state, a clamping force by the clamping means 24 is applied to each seal body 16 in addition to an elastic force by the fixing clip 17 so that the fitness between the seal body 16 and the flange is enhanced, thereby securing a sealing function.

When gaskets 25 are interposed between the fluid couplings 3 and the surfaces 4b of the center plate 4 in the fluid flow path assembly 2, fluid is prevented from being leaked from the portion between the fluid couplings 3 and the surfaces 4b.

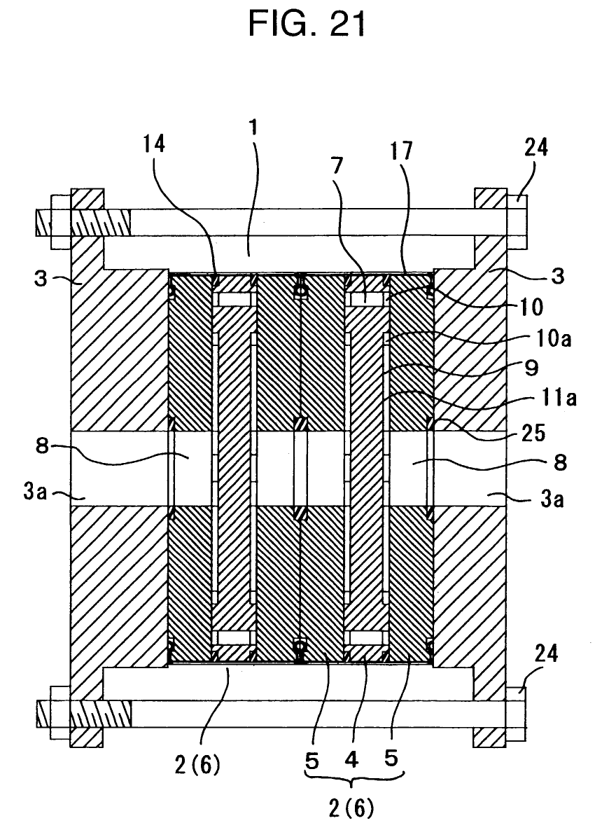

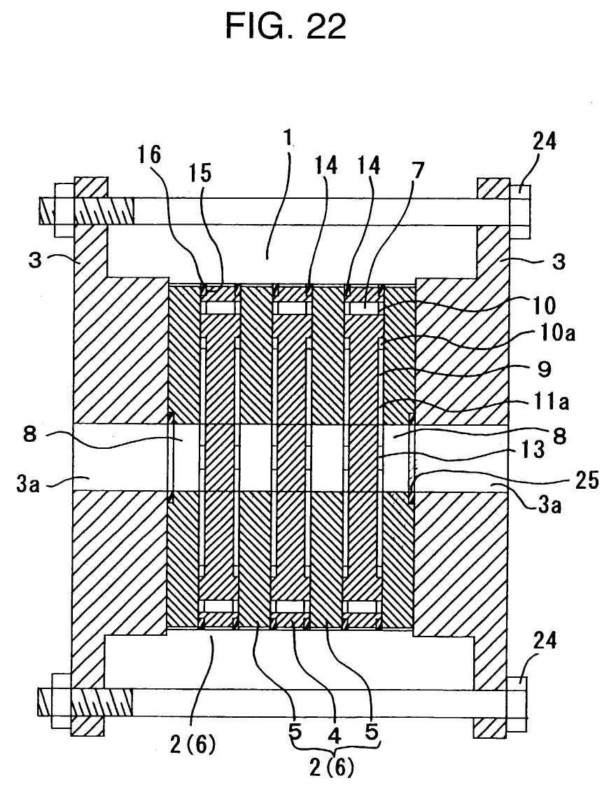

The number of fluid flow path assembly 2 can be appropriately set such that the fluid flow assembly 2 can be continuous with one another, if need be. That is, independent fluid flow assemblies 2 formed of three constituents of the center plate 4 and the side plates 5 are continuously provided via the gasket 25 in a state where the side plates 5 of each fluid flow path assembly 2 are brought into close contact with each other as shown in FIG. 21, or a plurality of fluid flow assemblies 2 are substantially provided by disposing the side plates 5 at both ends and alternately disposing appropriate number of center plate 4 and the side plates 5 between the side plates 5 as shown in FIG. 22, in which case the side plates 5 disposed in the midpoint can be used are common parts of the fluid flow assemblies 2 which are disposed adjacently so that the number of parts such as the gasket 25, the side plates 5 and the like can be reduced.

The gasket 25 is formed of the same material and shape as the seal body 16, and also a gasket fitting portion 26 on which the gasket 25 is fitted is formed in the same manner as the seal fitting portion 15.

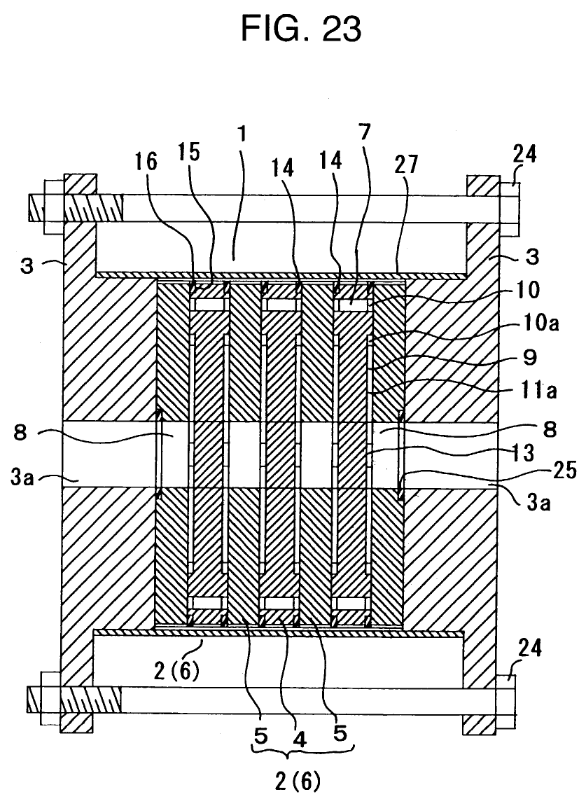

Still another embodiment of the stationary type fluid mixer 1 is illustrated in FIG. 23, wherein a protection caging 27 is used, and has an inner diameter which is slightly larger than an outer diameter of the laminated structure 6, and the appropriate numbers of fluid flow path assemblies 2 are accommodated inside the protection caging 27 and the fluid couplings 3 disposed on both sides of the protection caging 27 fixedly hold the fluid flow path assemblies 2.

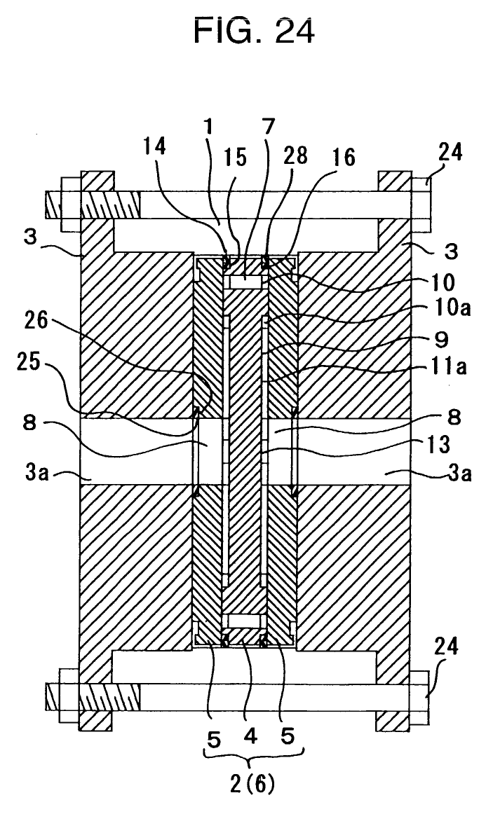

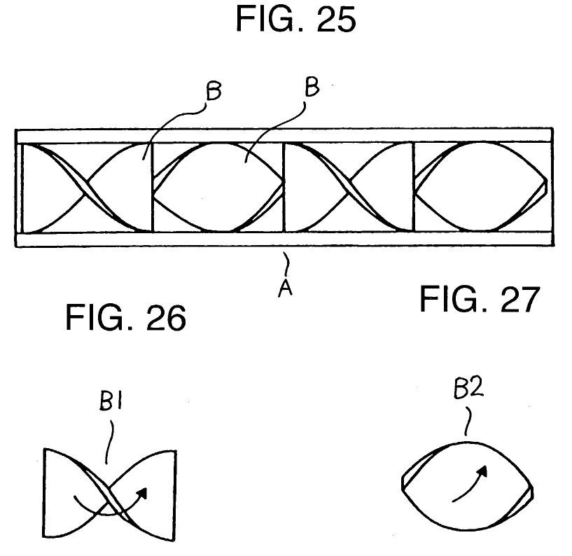

More still another embodiment of the stationary type fluid mixer 1 is illustrated in FIG. 24, in which an outer side of a seal fitting portion 15 is opened, and a backup ring 28 formed of a mechanical structure members such as metal, plastic, ceramic and the like which are generally used in a fluid apparatus can be fitted on the outer side of the seal body 16 of the seal fitting portion 15.

Described next is a mixing mechanism of fluid caused by flow of fluid in the stationary type fluid mixer 1. Different types of fluids or multiple fluids which flow at a desired pressure and flow rate from a connection port 3a of one fluid coupling 3 via pump (not shown) enter from the outlet/inlet ports 8 of the fluid flow path assembly 2 and collide against the center plate 4, and change their flow in a radial direction to flow inside complex communication flow paths 9 which are formed by the annular grooves 10, 10a and communication grooves 11, 11a, then separately enter the plurality of through-holes 7 from the communication flow paths 9. Then the multiple fluids change their flow in an axial direction inside the through-holes 7, and collide against the next side plate 5 to change their flow in a central direction and flow inside the communication flow paths 9 at the downstream side, and finally flow inside the respective fluid flow assemblies 2 and flow out from the connection port 3a of the other fluid coupling 3, whereby turbulence is generated in the flow of the fluids, thereby effecting mixing/dispersion of fluids.

Further, fluids are divided to separately enter into a plurality of communication grooves 11a which are located at the upstream side while they change their flow in a radial direction upon collision substantially perpendicularly against the planate bottom of the recesses 13 of one center plate 4 inside the communication flow paths 9, and flow in the communication grooves 11a and collide substantially perpendicularly against the side wall (arc surface) of the inner annular grooves 10a, and they separately enter in the circumferential direction. The fluids which flow separately mutually collide and merge inside the annular grooves 10a, then they enter the plurality of outer communication grooves 11 which communicate with the colliding spots. Thereafter, the fluid flow inside the communication groove 11 and collide substantially perpendicularly against the wall surface (arc surface) of the outer annular grooves 10, and separately flow in the circumferential direction, and the fluids which flow separately mutually collide and merge inside the annular grooves 10. The fluids enter the plurality of through-holes 7 which communicate with the colliding spots and flow inside the through-holes 7, then enter the annular grooves 10 of the center plate 4 positioned at the downstream, thereafter, they collide with each other substantially perpendicularly against the surface facing the annular grooves 10. Thereafter, they separately flow in the circumferential direction inside the annular grooves 10, then the separately flowing fluid collide and merge with each other inside the annular grooves 10, then enter the plurality of communication grooves 11 which communicate with the colliding spots, and flow centrifugally inside the communication grooves 11 and collide substantially perpendicularly against the wall surface (arc surface) in the annular grooves 10a and flow separately in the circumferential direction, then the separately flowing fluids collide and merge with each other in the annular grooves 10a, then enter plurality inner communication grooves 11a communicating with the colliding spots, thereafter they flow in the communication grooves 11 and enter the recesses 13, and the thus separately flowing fluids collide and merge mutually, and finally a mixed and dispersed fluid flows out from the outlet/inlet ports 8 of the side plates 5.

In such a manner, the fluids are mixed and dispersed by a shearing force which acts on the fluids in complex by the organic repetition of an impact strength which is generated when the fluids collide substantially perpendicularly against the side surfaces and groove bottoms of the annular grooves 10,10a, and an impact strength when the fluids collide head-on with each other inside the annular grooves 10, 10a, whereupon mixing/dispersion operation of the fluids in the radial direction inside the communication flow paths 9 and mixing/dispersion operation of the fluids in the central direction are effected in the same manner so that a uniform shearing force acts on the fluids in an entire mixing/dispersion area to uniformize the mixing/dispersion operation.

Further, when the flow path sectional areas of the annular grooves 10, 10a are set to be half as large as those of the through-holes 7, communication grooves 11, communication grooves 11a, the flow path sectional areas when the fluids separately flow and merge with each other are not changed so that flow rate of the fluids which flow in the respective flow paths inside the communication flow paths 9 have substantially the same speed, and hence the shearing force at the colliding, separately flowing and merging spots is substantially uniformized, thereby uniformizing mixing/dispersion operation of the fluid.

Further, when planate collision surfaces 12 are provided on side wall surfaces of the annular grooves 10, 10a against which the fluids collide, the fluids which flow out from the communication grooves 11, 11a collide perpendicularly against the planate collision surfaces 12 so that an impact energy generated thereby becomes higher than an impact energy generated when the fluids collide against an arc surface, thereby increasing the shearing force which is a factor of the mixing/dispersion operation.

Still further, when each tip end 31 side of the projections 30 is exposed to the interior of the outlet/inlet ports 8, the fluids which flow through the outlet/inlet ports 8 are subjected to the shearing operation by each ridge corner 32 of the exposed projections 30, and when the fluids collide against the bottom of the recesses 13 and separately enter the communication grooves 11a, the fluids are subjected the shearing operation by each tip end 31 of the projections 30, thereby increasing the shearing force which is a factor of the mixing/dispersion operation.

Subsequently, in the manner opposite to the flow of the fluid set forth above, namely, if the flow inlet side is positioned at the outlet/inlet ports 8 of the other side plate 5, the flow direction is merely inverted and the number of divisions is not changed without being influenced by the moving direction of the fluid so that a fundamental mixing/dispersion operation is the same.

Since each seal body 16 of the seal portions 14 is provided between the laminated surface 4a of the center plate 4 positioned outside the through-holes 7 and each laminated surface 5a of the side plates 5, the fluid is prevented from being leaked toward the outside from the fluid flow path assembly 2.

Still further, since the center plate 4 is elastically urged against the opposite surfaces of the side plates 5 by the fixing clip 17, the seal body 16 is also elastically urged against opposite surfaces of the side plates 5 so that even if a clamping force by the clamping means 24 is cancelled, the sealing property by the seal body 16 can be secured. In a state where the clamping force is cancelled, the gap X is defined between the laminated surface 4a of the center plate 4 and each laminated surface 5a of the side plates 5, and when the washing fluid is forced to flow into the fluid flow path assembly 2 in this state, it can flow in or out through the gap X so that the fluid which is influent to close contact spots which are defined when the laminated surface 4a of the center plate 4 and each laminated surface 5a of the side plates 5 are brought into close contact with each other.

Even if the clamping force by the clamping means 24 is cancelled, since the seal body 16 is elastically urged by the fixing clip 17, the fluid flow path assembly 2 can be detached in a state where the sealing function is provided.

Since a fluid pressure is not applied to the protection caging 27 or the backup ring 28 in the stationary type fluid mixer 1 having the protection caging 27 or the backup ring 28, and the protection caging 27 or backup ring 28 does not contact the fluid, an appropriate material can be used by such a stationary type fluid mixer 1 without limiting a mechanical strength or material so that the protection caging 27 or backup ring 28 can restrict positional displacement even if such positional displacement occurred when the seal body 16 is increased in diameter by the pressure inside the fluid flow path assembly 2 not withstanding the clamping force by the clamping means 24, thereby improving safety of the sealing function.

Still further, even if a plurality of fluid flow path assemblies 2 are continuously provided, since each center plate 4, side plates 5 constituting each fluid flow path assembly 2 and the side plates 5 are continuously provided while they are brought into continuously close contact with one another, the clamping force by the clamping means 24 acts uniformly on the seal body 16 of the fluid flow path assembly 2, thereby securing the sealing function at the entire sealing spots, reliably preventing the leakage of fluid, basically constituting the number of parts of the fluid flow path assembly 2 by three, sufficing the minimum number of the spots requiring the seal body 16 by at least two because the number of parts is three, and preventing the occurrence of a fluid reservoir spot in the communication flow paths 9 of the fluid flow path assembly 2.

Lastly, it is possible to restrict the positional displacement of the seal body 16 in the same manner as set forth above by increasing the number of the fixing clip 17 to be used. The stationary type fluid mixer 1 of the invention is not limited to the embodiments which are explained and illustrated as set forth above, and it is needless to say that the stationary type fluid mixer 1 can be changed or modified variously without departing from the scope of the gist of the invention.

### INDUSTRIAL APPLICABILITY

As explained in detail above, the invention comprises [a laminated structure 6 composed of a center plate 4 and side plates 5 which are laminated on the opposite surfaces of the center plate 4, the center plate 4 being bored at outer peripheral sides thereof to define a plurality of through-holes 7, the side plates 5 being bored at the central sides to define outlet/inlet ports 8, communication flow paths 9 for communicating with the outlet/inlet ports 8 and through-holes 7, the communication flow paths 9 comprised of a plurality of annular grooves 10, 10a formed concentrically in either a laminated surface 4a of the center plate 4 or laminated surfaces 5a of the side plates 5, and the annular groove 10 which is positioned at the outermost side of the annular grooves 10, 10a is allowed to communicate with the through-holes 7, a plurality of radial communication grooves 11 being defined between the inner and outer annular grooves 10, 10a, wherein the communication groove 11 which is positioned at the outermost side of the communication grooves 11 is positioned at a midpoint of the through-holes 7 in a circumferential direction, and a plurality of radial communication grooves 11a are defined on the laminated surface 4a of the inner side of the annular groove 10a which is positioned at the innermost side to communicate with the outlet/inlet ports 8, and the inner and outer communication grooves 11, 11a are positioned at the midpoint thereof in a circumferential direction, so that the increase and decrease of the number or divisions can be easily coped with the increase and decrease of the through-holes 7, the annular grooves 10, 10a, the communication grooves 11, 11a, and further, the number of divisions can be increase inside the fluid flow path assembly 2, thereby preventing the stationary type fluid mixer from becoming long and large sized as made in the background technology, obtaining fluid flow assemblies 2 which have the same outer shape but different in the number of divisions, increasing the degree of freedom of setting the number of divisions as the stationary type fluid mixer 1 when the fluid flow path assemblies 2 are used continuously, facilitating the adjustment of the degree of mixing/dispersion according to different types of fluid, reducing the number of parts because the side plates 5 can be used as common parts of the fluid flow path assemblies 2 which are adjacently disposed with each other in the case of configuration substantially provided with a plurality of the fluid flow path assemblies 2 as a whole. Further, since the communication flow paths 9 are defined in complex, the fluid is mixed and dispersed by the shearing force which acts on the fluid in complex which is caused by organic repetition of an impact energy when the fluids collide substantially perpendicularly against the side wall surface and the like and an impact energy when the fluids collide head-on with each other, completely differing from the mixing/dispersion principle of the static mixer of the background technology, and the separating operation of the background technology does not at all occur, thereby extremely enhancing the mixing/dispersion efficiency, and the mixing/dispersion operation inside the communication flow paths 9 in the radial direction and that in the central direction are effected in the same manner, thereby achieving the effect of uniformization of the mixing/dispersion owing to the action of the uniform shearing force in the entire mixing/dispersion area.

Further, since the flow path sectional areas of the through-holes 7 and the communication grooves 11, 11a are the same, and flow path sectional areas of annular grooves 10, 10a are the same, and the flow path sectional areas of the annular grooves 10, 10a are set to be half as large as those of the through-holes 7 and the communication grooves 11, 11a, the flow path sectional areas are not changed when the fluids collide separately flow and merge with each other so that flow rate of the fluids flowing in the flow paths inside the communication flow paths 9 is substantially the same, and hence the shearing force in the colliding, separately flowing and merging spots is substantially uniformized, thereby obtaining the effect of the uniformization of mixing/dispersion operation.

Still further, since planate collision surfaces 12 are provided on the sidewall surfaces of the annular grooves 10, 10a facing the communication grooves 11, 11a, the fluids which flow out from the communication grooves 11, 11a collide perpendicularly against the collision surfaces 12 so that an impact energy of the fluids generated thereby becomes higher than an impact energy of the fluids generated when the fluids collide against the arc surface, thereby increasing the shearing force which is a factor of mixing/dispersion operation to further enhance the mixing/dispersion efficiency.

More still further, since the tip end 31 side of the projections 30 is disposed to be exposed to the interior of the outlet/inlet ports 8, the fluids flowing in from the outlet/inlet ports 8 are subjected to shearing operation by the ridge corner 32 of the projections 30, and when the fluids collide against the bottom of the recesses 13 and separately flow into the communication grooves 11a, the fluids are also subjected to the shearing operation by the tip end 31 of the projections 30 so that the shearing force which is a factor of the mixing/dispersion operation is increased, thereby obtaining an effect of further enhancement of the mixing/dispersion efficiency.

Still further, since seal bodies 16 formed of rubber-like elastic body are provided between the laminated surface 4a of the center plate 4 positioned outside the through-holes 7 and laminated surface 5a of the side plates 5, and the fixing clip 17 made of a material of a leaf spring and formed substantially in U-shape is fitted on the outer side of the laminated structure 6, wherein since the side plates 5 are elastically urged against opposite surfaces of the central plate 4 by the fixing clip 17 to constitute the fluid flow path assembly 2, and the fluid flow path assembly 2 is clamped by and fixed to the fluid couplings 3, there are obtained excellent effects that the fluid is prevented from being leaked from the fluid flow path assembly 2 to the outside by the seal body 16, thereby performing an excellent effect capable of eliminating the housing A of the background technology, providing the stationary type fluid mixer 1 at a low cost, facilitating handling and assembling operation because the fluid flow path assembly 2 is unitized, preventing the fluid from being leaked from the fluid flow path assembly 2 because sealing property by the seal bodies 16 is secured even if the clamping force by the clamping means 24 is cancelled since the seal bodies 16 are elastically urged by the fixing clip 17, thereby improving safety, defining the gap X between the laminated surface 4a of the center plate 4 and the laminated surfaces 5a of the side plates 5 in a state where the clamping force is cancelled to enable washing fluid to flow into or out from the gap X, fluid which is influent to close contact spots can be washed without disassembling the fluid flow path assembly 2 in a state where the laminated surface 4a of the center plate 4 and the laminated surfaces 5a of the side plates 5 are brought into close contact with each other.

What is claimed is:

1. A stationary type fluid mixer comprising a laminated structure composed of a center plate and side plates which are laminated on the opposite surfaces of the center plate, the center plate being bored at outer peripheral sides thereof to define a plurality of through-holes, the side plates being bored at the central sides to define outlet/inlet ports, communication flow paths for communicating with the outlet/inlet ports and through-holes, and seal bodies formed of rubber-like elastic body provided between the laminated surface of the center plate positioned outside the through-holes and the laminated surface of the side plates to form a fluid flow path assembly wherein the fluid flow path assembly is fixedly held by fluid couplings.

2. A stationary type fluid mixer comprising a laminated structure composed of a center plate and side plates which are laminated on the opposite surfaces of the center plate, the center plate being bored at outer peripheral sides thereof to define a plurality of through-holes, the side plates being bored at the central sides to define outlet/inlet ports, communication flow paths for communicating with the outlet/inlet ports and through-holes, the communication flow paths comprised of a plurality of annular grooves formed concentrically in either a laminated surface of the center plate or laminated surfaces of the side plates, and the annular groove which is positioned at the outermost side of the annular grooves is allowed to communicate with the through-holes, a plurality of radial communication grooves being defined between the inner and outer annular grooves, wherein the communication groove which is positioned at the outermost side of the communication grooves is positioned at a midpoint of the through-holes in a circumferential direction, and a plurality of radial communication grooves are defined on the laminated surface of the inner side of the annular groove which is positioned at the innermost side to communicate with the outlet/inlet ports, and the inner and outer communication grooves are positioned at the midpoint thereof in a circumferential direction, and seal bodies formed of rubber-like elastic body are provided between the laminated surface of the center plate positioned outside the through-holes and the laminated surface of the side plates to form a fluid flow path assembly and the fluid flow path assembly is fixedly held by fluid couplings.

3. The stationary type fluid mixer according to claim 2, wherein flow path sectional areas of the through-holes and the communication grooves are the same, and the flow path sectional areas of annular grooves are the same, and the flow path sectional areas of the annular grooves are set to be half as large as those of the through-holes and the communication grooves.

4. The stationary type fluid mixer according to claim 1 or 2, wherein planate collision surfaces are provided on the sidewall surfaces of the annular grooves facing the communication grooves.

5. The stationary type fluid mixer according to claim 2, 3 or 4, wherein a tip end of each projection formed by the communication grooves is exposed to an interior of the outlet/inlet ports to constitute the fluid flow path assembly.

6. The stationary type fluid mixer according to claim 1, 2, 3, 4 or 5, wherein a fixing plate made of a material of a leaf spring and formed in substantially U-shape is fitted on the outer side of the laminated structure, and the side plates are elastically urged by the fixing clip against opposite surfaces of the center plate to constitute the fluid flow path assembly.
